(19) United States
(12) Patent Application Publication
(10) Pub. No.: US 2006/0133322 A1
(43) Pub. Date: Jun. 22, 2006

(54) Method and apparatus for controlling rate selection for mobile stations in a communication network

(76) Inventors: Rath Vannithamby, San Diego, CA (US); Tao Wu, Carlsbad, CA (US)

Correspondence Address: COATS & BENNETT, PLLC, P O BOX 5, RALEIGH, NC, 27602, US

(21) Appl. No.: 11/018,108

(22) Filed: Dec. 21, 2004

(51) Int. Cl. H04B 7/216

(52) U.S. Cl. 370/335; 370/235

(57) ABSTRACT

A base station monitors mobile station response to rate grants by the base station to determine rate control violations by the mobile station. A rate control violation occurs when the mobile station fails to transmit at an expected rate after indicating a need to increase its transmit rate, or when the mobile station increases its transmit rate to the expected rate but transmits an unacceptable number of erroneous frames at the increased rate. The base station uses the observed rate control violations by the mobile station in making rate grant decisions.

### BACKGROUND OF THE INVENTION

The present invention generally relates generally to reverse packet data channels in CDMA networks, and more particularly, to a policing mechanism to control rate selection for mobile stations transmitting on a reverse packet data channel.

The most recent revisions to the cdma2000 standard introduced a reverse packet data channel (R-PDCH) that provides high-speed packet data services to mobile stations. The R-PDCH carries packet data from the mobile station to the base station in 10 ms frames at data rates ranging from 19.2 kbps to 1.8432 Mbps. The cdma200 standard includes a number of different rate control methods to enable the base station to control the data transmission rate of the mobile station on the R-PDCH, which may be generally classified as differential rate control and absolute rate control methods.

With differential rate control, each mobile station initially begins transmitting at a specified minimum rate (sometimes called the autonomous rate) and then is allowed to vary its data rate depending on factors such as the channel conditions of the mobile stations, power availability, buffer levels at the mobile station, and load levels at the base station.

A base station measures the load at the base station and transmits rate control bits (sometimes called reverse activity bits) to the mobile stations based on the loading at the base station. The mobile stations adjust their data transmission rates up or down to the next rate level depending on the state of the rate control bit. Differential rate control techniques include common rate control and dedicated rate control. Common rate control is a form of differential rate control where the same rate control bits are transmitted to all of the mobile stations served by the base station. In dedicated rate control, the mobile stations transmit a mobile station status indicator bit (MSIB) to the base station on the reverse packet data control channel (R-PDCCH). The MSIB is used by the mobile station to indicate that it has enough power headroom and enough data in its data buffer to increase its data transmission rate. The base station uses the MSIBs from the mobile stations to determine whether to increase the data transmission rate of the mobile stations in the next frame, and generates separate rate control bits for each mobile station.

In absolute rate control (also known as scheduling), a scheduler at the base station determines the data transmission rates of the mobile stations based on rate requests from the mobile stations. The mobile stations transmit an implicit rate request to the base station over the reverse request channel (R-REQCH) and the base station grants the requests if it has available resources. The rate request includes rate control information such as the buffer level, QoS requirements and available power headroom. The base station derives the requested rate from the rate control information in the rate request. Rate decisions are conveyed from the base station to the mobile station by transmitting the packet size that the mobile station is to use for transmission on the R-PDCH.

The efficiency of the dedicated rate control and absolute rate control methods depend on the ability of the mobile station to accurately determine its power headroom and buffer levels. When the mobile station considers the available power headroom, it should take into account not only the extra power (traffic-to-pilot power ratio) it has available, but also potential power control changes that might consume a portion of the available transmit power in the future. If channel conditions worsen, the mobile station may need to increase its transmit power in order to maintain its current data transmission rate. In a fast-varying radio channel, the mobile station should be more conservative and reserve a larger power headroom than in slow-varying radio conditions. In slow-varying radio conditions, the mobile station can be more aggressive and reserve a smaller power headroom.

Similarly, when considering buffer level, the mobile station needs to take into account how much data is likely to accumulate in the mobile station between the time the buffer level is reported and the time the mobile station transmits at the new scheduled rate. In either case, if mobile station is allocated with the requested resources, the system resources should allow for retransmission of data packets.

A greedy mobile station is one that consistently overestimates its power headroom and/or buffer levels. In either case, system resources will be unnecessarily wasted or underutilized. In situations where the mobile station overestimates the available power headroom, it may not be able to transmit data at the granted rate. If the mobile station tries to transmit data at the granted rate, the packet erasure rate may increase dramatically and the mobile station will be required to retransmit the failed packets, thereby unnecessarily wasting system resources. If the mobile station elects to transmit at a rate lower than the granted rate, then system resources reserved by the base station to support the higher data rate would be wasted. Similarly, if the mobile station exaggerates its buffer level, the mobile station may not have enough data to send to the base station at the requested rate. The mobile station may elect to transmit at a lower rate or pad the data in its buffer with fill bits to transmit at the granted rate. In either case, the resources reserved by the base station to support the higher data rate are wasted.

Currently, there is no mechanism to correct the behavior of a greedy mobile station that consistently overestimates power headroom and/or buffer levels. System throughput could be improved if the base station had some mechanism to detect greedy mobile stations and to correct the behavior of the greedy mobile stations.

### SUMMARY OF THE INVENTION

The present invention provides a method of controlling the data transmission rate of a mobile station on a reverse packet data channel. A rate controller at the base station determines rate control commands to send to the mobile station. A policing unit in the rate controller monitors rate control violations by the mobile station. The rate control violations by the mobile station are taken into account by the rate controller in determining the rate control commands sent to the mobile station. Rate control violations may, for example, comprise a failure of a mobile station to transmit at a granted rate, failure of a mobile station to increase its transmit rate in response to a rate control command from the base station, or the transmission by the mobile station of an erroneous frame at a granted rate.

In one embodiment of the invention, the rate controller comprises a rate scheduler to determine a scheduled rate of the mobile station based on rate requests received from the mobile station. The rate requests from the mobile station include estimates of power headroom and buffer levels at the mobile station, and the quality of service (QoS) requirements of the mobile station. The scheduled rate may be modified by the rate controller based on past rate control violations.

In another embodiment of the invention, the base station receives mobile station status indicator bits (MSIBs) from the base station. The MSIBs indicate whether the mobile station has sufficient power headroom and data in its buffer to transmit at a higher rate. The rate controller determines whether to allow the mobile station to increase its transmit rate based on the mobile station's history of rate control violations. For example, the rate controller may probabilistically grant requests for rate increases based on the mobile station's history of rate control violations.

The present invention mitigates the behavior of greedy mobile stations that consistently overestimate power headroom and buffer levels. Without an effective policing mechanism, greedy mobile stations that consistently overestimate power headroom and buffer levels would be granted, on average, higher rates than well-behaved mobile stations that accurately estimate power headroom and buffer levels. The policing mechanism penalizes mobile stations that request a specified rate or rate increase and then fail to transmit at the requested rate, thereby wasting resources reserved for the mobile station.

### BRIEF DESCRIPTION OF THE DRAWINGS

FIG. 1 is a block diagram of a mobile communication network.

FIG. 2 is a block diagram illustrating an exemplary base station in a wireless communication network.

FIG. 3 is a block diagram illustrating an exemplary rate controller for a base station in a wireless communication network that implements absolute rate control.

FIG. 4 is a graph illustrating the relationship between a penalty factor and a violation level according to one embodiment of the invention.

FIG. 5 is a flow chart illustrating an exemplary procedure implemented by the rate controller shown in FIG. 3.

FIG. 6 is a block diagram illustrating an exemplary rate controller for a base station in a wireless communication network that implements dedicated rate control.

FIG. 7 is a flow chart illustrating an exemplary procedure implemented by the rate controller shown in FIG. 6.

### DETAILED DESCRIPTION OF THE INVENTION

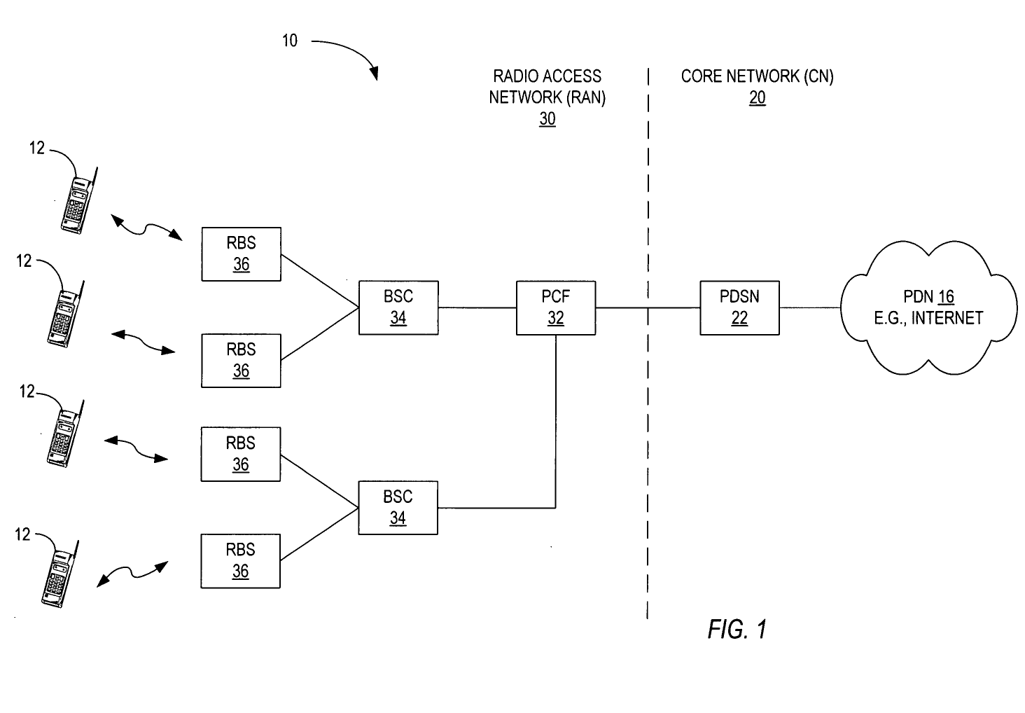

FIG. 1 illustrates logical entities of an exemplary wireless communication network 10 that provides packet data services to mobile stations 12. The wireless communication network 10 is a packet-switched network, such as a CDMA network, WCDMA network, GSM/GPRS network, EDGE network, or UMTS network. FIG. 1 illustrates a wireless communication network 10 configured according to the cdma2000 (IS2000) standards. Wireless communication network 10 comprises a packet-switched core network 20 and a radio access network (RAN) 30. The core network 20 includes a Packet Data Serving Node (PDSN) 22 that connects to an external packet data network (PDN) 16, such as the Internet, and supports PPP connections to and from the mobile station 12. Core network 20 adds and removes IP streams to and from the RAN 30 and routes packets between the external packet data network 16 and the RAN 30. RAN 30 connects to the core network 20 and gives mobile stations 12 access to the core network 20.

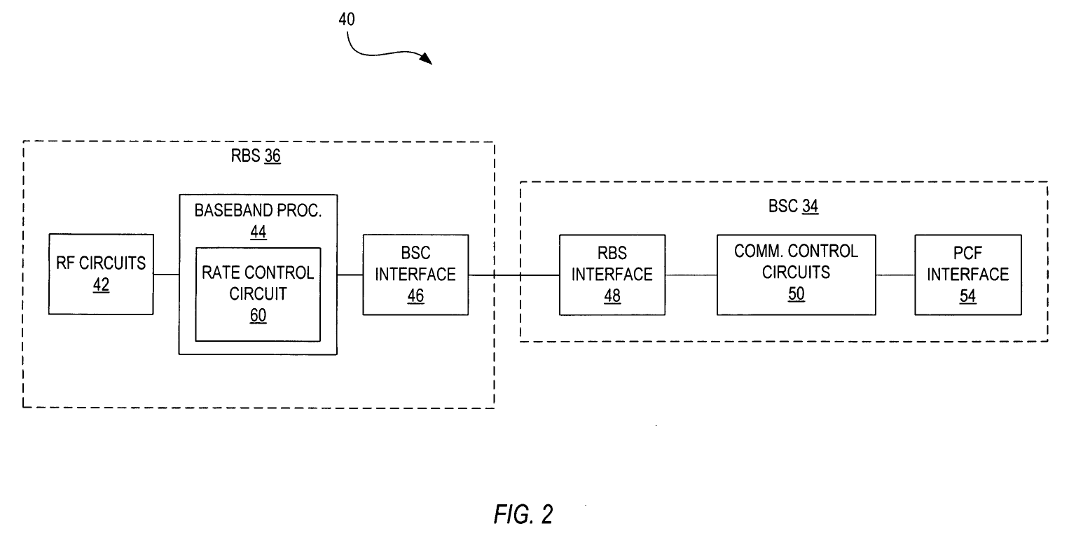

RAN 30 includes a Packet Control Function (PCF) 32, one or more Base Station Controllers (BSCs) 34 and one or more radio base stations (RBSs) 36. The primary function of the PCF 32 is to establish, maintain, and terminate connections to the PDSN 22. The BSCs 34 manage the radio resources within their respective coverage areas. The RBSs 36 include the radio equipment for communicating over the air interface with mobile stations 12. A BSC 34 can manage more than one RBSs 36. In cdma2000 networks, a BSC 34 and an RBS 36 comprise a base station 40 (FIG. 2), which is described in more detail below. The BSC 34 is the control part of the base station 40. The RBS 36 is the part of the base station 40 that includes the radio equipment and is normally associated with a cell site. In cdma2000 networks, a single BSC 34 may comprise the control part of multiple base stations 40. In other network architectures based on other standards, the network components comprising the base station 40 may be different but the overall functionality will be the same or similar.

FIG. 2 illustrates exemplary details of a base station 40 in a cdma2000 network. The base station components in the exemplary embodiment are distributed between a RBS 36 and a BSC 34. The RBS 36 includes RF circuits 42, baseband processing and control circuits 44, and interface circuits 46 for communicating with the BSC 34. In the embodiment shown in FIG. 2, the baseband processing and control circuit 44 includes a rate control circuit 60 performing rate control functions and policing functions as described further below. It will be recognized, however, that the rate control circuit could alternatively be located at the BSC 34. The BSC 34 includes interface circuits 48 for communicating with the RBS 36, communication control circuits 50, and interface circuits 54 for communicating with the PCF 32. The communication control circuits 50 include radio resource management circuits to manage the radio and communication resources used by the base station 40. The communication control circuits 50 may comprise one or more processors programmed to carry out the functions of the communication control circuits 50.

The most recent revisions to the cdma2000 standard (Revision D) introduced a reverse packet data channel (R-PDCH) that provides high-speed packet data services to mobile stations 12. The R-PDCH carries packet data from the mobile station 12 to the base station 40 in 10 ms frames at data rates ranging from 19.2 kbps to 1.8432 Mbps. The cdma2000 standard includes a number of different rate control mechanisms to enable the base station 40 to control the data transmission rate of mobile station 12 on the R-PDCH, which may be generally classified as differential rate control methods and absolute rate control methods. The various rate control mechanism are describe in Medium Access Control (MAC) Standard for cdma2000 Spread Spectrum Systems, TIA-2000.3-D (March 2004) published by the Telecommunications Industry Association.

In absolute rate control (also known as scheduling), mobile station 12 requests permission to transmit data on the R-PDCH. The request, referred to herein as a rate request, is transmitted to base station 40 on the reverse request channel (R-REQCH). The rate request includes buffer level, power headroom, and QoS requirements of the mobile station 12, which serve as a rate request. A rate controller 60 at the base station 40 (FIG. 2) schedules the data transmission rate of the mobile stations 12 based on the reported power headroom, buffer level, and QoS requirements of the mobile station 12 and load conditions at the base station 40. Scheduling decisions are transmitted from the base station 40 to the mobile station 12 on the forward Grant Channel (F-GCH). More particularly, the base station 40 transmits the packet size that the mobile station 12 is to use for transmission on the R-PDCH. Because the frame size is fixed, the mobile station 12 can determine the granted rate based on the packet size.

In differential rate control, each mobile station 12 initially begins transmitting at a specified minimum rate (sometimes called the autonomous rate) and then is allowed to vary its data rate depending on factors such as the channel conditions, power availability, buffer levels at the mobile station 12 and load conditions at the base station 40. The base station 40 transmits rate control bits (RCBs, sometimes called reverse activity bits) to the mobile station 12 to indicate whether the mobile station 12 should increase or decrease its transmission rate or hold at its current rate. The RCBs are transmitted to the mobile station 12 over the Forward Rate Control Channel (F-RCCH). The mobile stations 12 adjust their data transmission rates up or down to the next rate level, or hold at the current rate, depending on the RCB.

Differential rate control techniques include common rate control and dedicated rate control. Common rate control is a form of differential rate control where the same RCB is transmitted to all of the mobile stations 12 served by the base station 40. Common rate control does not require any signaling from the mobile station 12. In dedicated rate control, the rate control bit is determined separately for each mobile station 12. Each mobile station 12 transmits a mobile station status indicator bit (MSIB) to the base station 40 on the reverse packet data control channel (R-PDCCH). The MSIB indicates to the base station 40 that the mobile station 12 has enough power headroom and enough data in its data buffer to increase its data transmission rate to the next rate level. The MSIB also serves as an implicit request by the mobile station 12 for a rate increase. If the load levels at the base station 40 permit, the base station 40 may grant a rate increase to selected ones of the mobile station 12. When differential rate control is used, the rate controller 60 determines the rate control commands (e.g., RCBs) to transmit to the mobile station 12.

In both absolute rate control and dedicated rate control, the mobile station 12 must estimate its power headroom and buffer levels. When estimating power headroom, the mobile station 12 should take into account power reserved for potential future power control needs. For example, if channel conditions worsen on the reverse packet data channel, the mobile station 12 may be required to increase its transmit power to maintain its current data rate. Further, since hybrid ARQ is used on the reverse packet data channel, the mobile station 12 may be required to re-transmit frames received in error at a higher power. Thus, estimation of the power headroom requires some prediction by the mobile station 12 of future power needs. Similarly, the mobile station 12 should take into account possible changes in buffer levels when it reports its buffer level to the base station 40. Determining changes in the buffer level requires the mobile station 12 to predict the rate at which bits are arriving at the buffer, the rate at which bits are being transmitted, and how many of those bits will need to be re-transmitted.

The standards do not specify how the mobile station 12 is to compute its power headroom or buffer levels. A mobile station 12 that consistently overestimates its power headroom and buffer levels (referred to herein as a greedy mobile station) will in general be granted higher rates than a mobile station 12 that accurately estimates its power headroom and buffer levels. However, a greedy mobile station 12 may not be able to transmit at the higher rate due to insufficient power or insufficient data in its buffer. Because the base station 40 reserves resources for the mobile station 12 based on the granted rate, the mobile station's failure to transmit at the granted rate wastes communication resources and decreases system throughput. Similarly, if the greedy mobile station 12 tries to transmit at the granted rate but has insufficient power, the frame error rate for the mobile station 12 may increase dramatically. The increased frame error rate also results in a waste of communication resources since the mobile station 12 will be required to re-transmit the frames received in error.

The present invention provides a mechanism to police mobile station 12 behavior as it pertains to rate control. A policing mechanism at the base station 40 penalizes a mobile station 12 that indicates a need for an increased rate and then fails to increase its transmit rate to the expected rate when the base station 40 grants it permission to do so. The policing mechanism of the present invention may be employed in both absolute rate control and dedicated rate control. In the case of absolute rate control, the mobile station 12 indicates a need for a rate increase by sending a rate request to the base station 40 over the R-REQCH. In the case of dedicated rate control, the mobile station indicates a need for a rate increase by setting the MSIB to “1.” If conditions permit and the base station 40 has sufficient resources, the base station 40 will send a rate grant to the mobile station 12 responsive to the rate request in the case of absolute rate control, or an “up” command in the case of dedicated rate control. A rate control violation occurs when the mobile station 12 fails to increase its rate to the expected level indicated by its rate request. If the rate granted by the base station is higher than the rate indicated by the rate request in the case of absolute rate control, the failure of the mobile station 12 to increase to the granted rate is not necessarily be considered a rate control violation, since the mobile station 12 did not request the higher rate. In this case, the mobile station 12 should not be penalized. A rate control violation may be considered to have occurred if the mobile station 12 increases, and if its transmit rate to the rate indicated by the rate request if an unacceptable number of frame errors occurs at the increased rate.

In an exemplary embodiment of the invention, the policing unit monitors the rate control violations of the mobile station 12 during a sliding window W and quantifies the rate control violations in terms of number and/or severity. A tracking unit generates a tracking value that provides a measure of the rate control violations by the mobile station 12. A penalty function in the tracking value is then used to determine whether to grant the mobile station 12 a requested rate and/or to determine the granted rate.

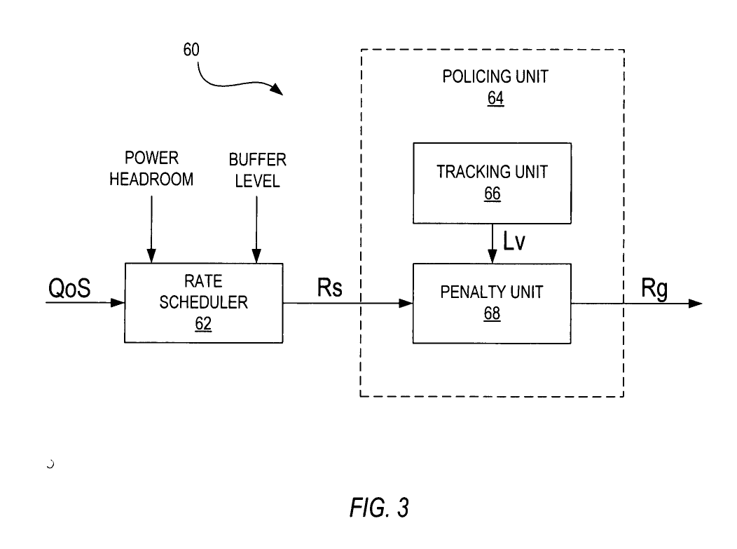

FIG. 3 illustrates an exemplary rate controller 60 for implementing the absolute rate control mechanism according to one embodiment of the present invention. The rate controller 60 may be implemented in one or more processors. The rate controller 60 comprises a rate scheduler 62 and a policing unit 64. The rate scheduler 62 determines a scheduled rate for a mobile station 12 based on the power headroom and buffer level reported by the mobile station 12 in a rate request message, and the quality of service requirements of the mobile station 12. The rate scheduler 62 may be any conventional rate scheduler deploying any known decision algorithm. In a conventional system, the rate determined by the rate scheduler 62 would be the granted rate for the mobile station 12. In the present invention, the scheduled rate from the rate scheduler is treated as a provisional rate subject to modification by the policing unit 64.

The policing unit 64 comprises a tracking unit 66 and a penalty unit 68. The tracking unit 66 monitors the mobile station's behavior in response to rate grants, which is referred to herein as the rate change history. The tracking unit 66 generates a violation level that provides a measure of the mobile station's compliance with granted rates. The scheduled rate determined by the rate scheduler 62 and the violation level generated by the tracking unit 66 are supplied to the penalty unit 68. The penalty unit 68 adjusts the scheduled rate determined by the rate scheduler 62 based on the violation level. If a mobile station 12 consistently transmits at the granted rate, it will not be penalized. In this case, the scheduled rate provisionally determined by the rate scheduler 62 will be the granted rate. However, if the mobile station 12 fails to transmit at the granted rate, the penalty unit 68 may operate to adjust the scheduled rate. In general, the penalty applied by the penalty unit 68 will vary, depending on the number and severity of the mobile station's rate control violations.

In a preferred embodiment of the invention, the tracking unit 66 monitors the mobile station's behavior in response to rate grants by the base station 40 over a predefined window W. The tracking unit 66 should take into account both the number and degree of the rate control violations. An exemplary tracking function is given by:

$${L}_{V} = {\sum }_{W} \frac{{R}_{G} - {R}_{T}}{{R}_{G}} \qquad Eq . 1$$

where L_{V} measures the level of violations by the mobile station 12, R_{G} is the granted rate, and R_{T} is the actual transmission rate of the mobile station 12. W is the window size measured in frames. The numerator in the summation of Equation 1 is the difference between the granted rate R_{G} and the actual transmission rate R_{T} of the mobile station 12 for a given frame n. If desired, a frame received in error may be regarded as having a transmission rate R_{T} of 0 for purposes of calculating the violation level regardless of the of the actual transmission rate. This rate difference is divided by the granted rate R_{G} to yield a normalized difference. The normalized difference for each frame over the window W is summed to yield a measure of the level of the violations by the mobile station 12. The level L_{V} of violations serves as the violation level that is input to the penalty unit 68.

Equation 2 shows an alternative tracking function implemented by tracking unit 66 that mitigates the penalty when the mobile station transmits at a rate below the autonomous rate.

$${L}_{V} = {\sum }_{W} \frac{{R}_{G} - max ( {R}_{T} , {R}_{AUTO} )}{{R}_{G}} \qquad Eq . 2$$

In Equation 2, the normalized difference is based on the difference between the granted rate and the actual transmission rate where the actual transmission rate is greater than the autonomous rate. If the actual transmission rate is less than the autonomous rate, the tracking function uses the autonomous rate to compute the normalized difference. This function may be used, for example, when the network operator wants to guarantee the autonomous rate.

Equation 3 illustrates another exemplary tracking function implemented by tracking unit 66:
L_{V}=N_{V}=ΣVε{0,1} Eq. 3
where V equals 1 or 0 depending on whether a rate control violation occurs. In a preferred embodiment, V=1 if there is a rate control violation and V=0 if there is no rate control violation. The tracking function in Equation 3, in effect, counts the number of rate control violations over a predetermined window W. Failure to transmit at a granted rate may be counted as a rate control violation. Also, transmitting a frame in error may be counted as a rate control violation. In any event, penalty unit 68 uses the violation level output by the tracking unit 66 to modify the scheduled rate provisionally determined by the rate scheduler 62. In general, the penalty unit 68 should increase the penalty for rate violations (e.g., failure to transmit at the granted rate) based on the number and severity of the violations. The violation level output by the tracking unit 66 quantifies the degree or level of the rate violations by the mobile station 12. An exemplary penalty function is given by:

$$P ( r = {r}_{n} ) = 1 - {ⅇ}^{α ( 1 - \frac{W}{{L}_{V}} )} \qquad Eq . 4$$

The penalty function given by Equation 4 returns a value between 0 and 1. Assuming that the mobile station 12 commits no rate violations during the window W, the actual transmission rate R_{T} will equal R_{G}. In this case, the violation level equals 0 and the penalty factor will equal 1. At the other extreme, if the mobile station 12 is not able to transmit and R_{T} is always 0, the violation level L_{V} will equal W and the penalty factor will equal 0. In most instances, the actual transmission rate of the mobile station 12 will occasionally be lower than the granted rate so that a value between 0 and 1 would be expected for both the violation level and the penalty factor.

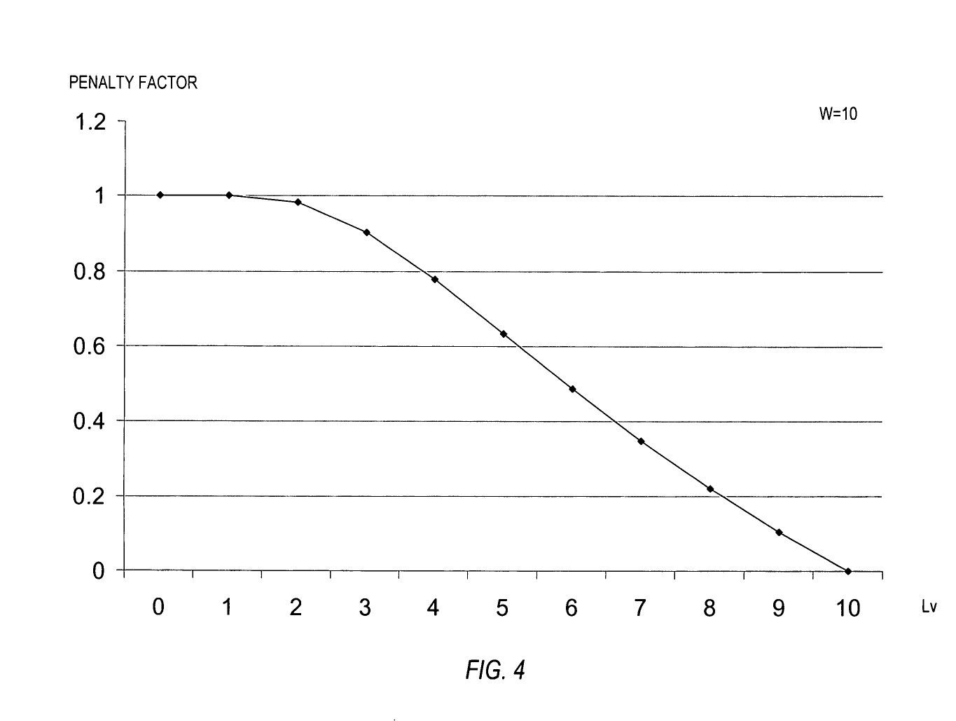

FIG. 4 is a graph illustrating the relationship between the violation metric Lv and the penalty factor P in one exemplary embodiment of the invention where the window size W equals 10 frames. As shown in FIG. 4, the value of Lv ranges from 0 to 10 and the penalty factor varies non-linearly from 1 to 10 as a function of the violation level Lv. It should be noted that a lower penalty factor equates to a greater penalty to a mobile stations. Of course, other penalty functions could be used including a linear penalty function. One advantage of the non-linear penalty function is that it treats mobile stations that commit a large number of rate change violations more harshly than mobile stations committing only a small number of violations.

The penalty factor computed by the penalty unit 68 is used to modify the scheduled rate determined by the rate scheduler 62. In one exemplary embodiment of the invention, the policing unit 64 may probabilistically grant or deny permission to the mobile station 12 to transmit at the scheduled rate determined by the rate scheduler 62. With this approach, the granted rate will equal the scheduled rate determined by the rate scheduler 62 if permission to transmit is granted, or the granted rate will equal 0 if permission to transmit is denied. In this embodiment, the penalty factor gives a probability of granting permission to transmit the mobile station 12. For example, if the penalty factor equals 0.68, the probability of the scheduled rate being granted is 68%. One way to implement the probabilistic approach is to generate a random number between 0 and 1 and to compare the random number to the penalty factor. If the penalty factor is greater than or equal to the random number, permission to transmit at the scheduled rate is granted. Otherwise, permission to transmit at the scheduled rate is denied and the granted rate is set to 0.

In another embodiment of the invention, the scheduled rate provisionally determined by the rate scheduler 62 is reduced by an amount determined by the penalty factor. For example, the scheduled rate determined by the rate scheduler 62 can be multiplied by the penalty factor to determine the granted rate. For example, the granted rate R_{G} may be calculated according to:
R_{G}=P(r=rₙ)xR_{S} Eq. 5
If R_{G} is not a possible transmit rate, then R_{G} may be rounded up or down to the next possible rate.

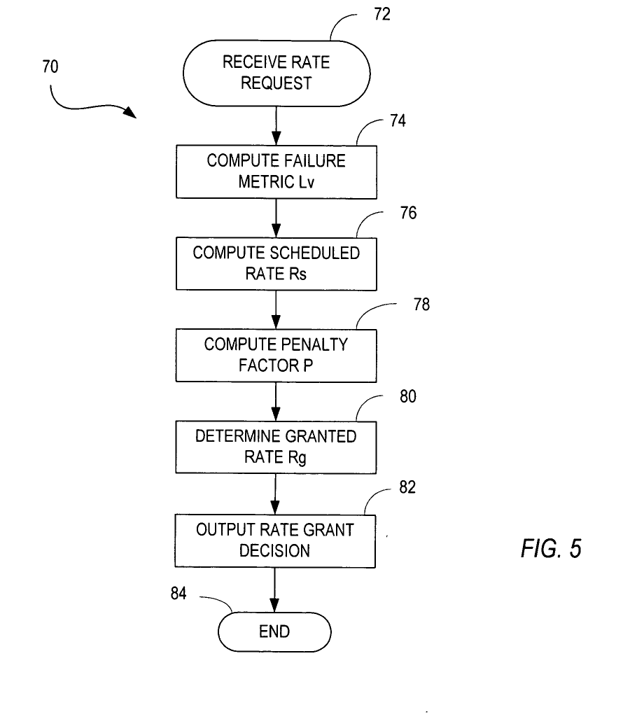

FIG. 5 is a flow diagram illustrating an exemplary procedure 70 implemented by the rate controller 60 in FIG. 3. The procedure 70 starts when the rate controller 60 receives a rate request from the mobile station 12 over the reverse request channel (R-REQCH) (block 72). The rate controller 60 calculates the violation level L_{V} (block 74) over a window W according to Equations 1, 2, or 3 above. The rate scheduler 62 within the rate controller 60 calculates a scheduled rate R_{S} using any known scheduling algorithm (block 76). The penalty function then computes a penalty factor (block 78) according to Equation 4 above and uses the penalty factor to determine the granted rate (block 80). The rate controller 60 then outputs the rate grant decision (block 82) for transmission to the mobile station 12. As noted above, depending on how the penalty function is applied, the granted rate may be equal to the scheduled rate RS, or a rate less than the scheduled rate. The policing unit 64 could also deny permission to transmit so that the granted rate is effectively equal to 0. The procedure ends (block 84) after the rate grant decision is transmitted to the mobile station 12.

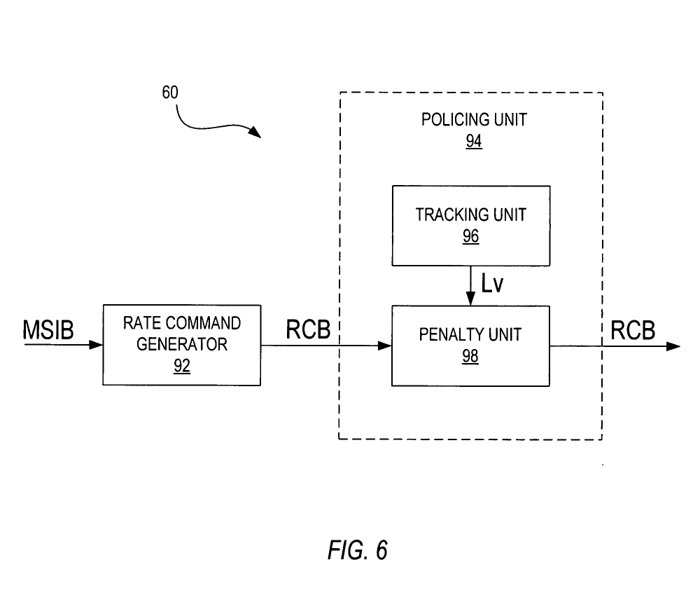

FIG. 6 illustrates an alternate embodiment of the present invention where dedicated rate control is used by the rate controller 60. The rate controller 60 shown in FIG. 6 comprises a command generator 92 and policing unit 94. The command generator 92 receives a mobile station status indicator bit (MSIB) from the mobile station 12. The MSIB indicates whether the mobile station 12 is able to increase its data transmission rate. The mobile station 12 sets the MSIB equal to 1 to indicate that it has sufficient power headroom and data in its buffer to increase its data transmission rate from its current rate to the next higher data rate. The mobile station 12 sets the MSIB equal to 0 to indicate that the mobile station 12 is not able to increase its data rate. The MSIB from the mobile station 12 is used by the command generator 92 to determine the rate control bit (RCB) to send to the mobile station 12. The determination of the rate control bit is done in a conventional fashion and may take into account factors such as the loading at the base station 40 and the channel conditions on the reverse packet data channel between the mobile station 12 and the base station 40. In most instances, the rate control bit comprises a single command. Using tri-state signaling, the RCB may have a value of +1, −1, and 0. Conventionally, a value of +1 is interpreted by the mobile station 12 as a command to increase to the next higher transmit rate, a value of −1 is interpreted as a command to decrease to the next lower transmission rate, and a value of 0 is interpreted as a command to hold at a current rate. In other embodiments of the invention, the rate control command may comprise a multi-bit rate control command. With a multi-bit rate control command, the rate controller 60 can instruct the mobile station 12 to hold, or to increase or decrease by one or more rate levels. For purposes of explanation, it is assumed in the subsequent discussion that the base station 40 sends a single RCB.

The RCB generated by the command generator 92 is input to the policing unit 94. The policing unit 94 includes a tracking unit 96 and a penalty unit 98. The tracking unit 96 computes a violation level that provides a measure of rate control violations by the mobile station 12. In one embodiment of the invention, the tracking unit 96 counts the number N_{V} of rate change violations over a sliding window W, where W is the number of frames in the window as shown in Equation 3. The count N_{V} is supplied to the penalty unit 98 and serves as the violation level. The penalty unit 98 computes a penalty factor based on the count N_{V}. An exemplary penalty function is given by:

$$P ( r \text{:} r \to {r}_{n + 1} ) = 1 - {ⅇ}^{α ( 1 - \frac{W}{{N}_{V}} )} \qquad Eq . 6$$

When the number of rate control violations N_{V} is 0, the penalty factor equals 1. When N_{V} is greater than 0, the penalty factor varies non-linearly from 1 to 0.

The penalty factor computed by the penalty unit 98 may be used in a number of ways to penalize the mobile station 12. In one embodiment of the invention, the rate controller 60 probabilistically grants rate increases, depending upon the penalty factor. In this embodiment, the penalty factor functions as a rate increase probability. That is, when the RCB provisionally determined by the command generator 92 equals 1, the penalty unit 98 determines whether to transmit to the mobile station 12 a “1” or “0,” depending upon the penalty factor. This determination can be made by generating a random number and comparing the random number Rₙ to the penalty factor. If the penalty factor is greater than the random number Rₙ, the RCB remains unchanged, i.e., RCB=1. On the other hand, if the penalty factor is less than the random number Rₙ, the RCB is changed from 1 to 0. The penalty unit 98 is not used when the RCB from the command generator 92 is 0 or −1.

In another embodiment of the invention, the policing unit 94 may compare the penalty factor to a threshold and change the RCB depending upon the outcome of the comparison. For example, assume that a threshold T is set equal to 0.65. If the penalty factor is greater than 0.65, the penalty factor leaves the RCB provisionally determined by the command generator 92 unchanged. If the penalty factor is less than the threshold, the policing unit 94 changes the RCB output by the command generator 92 from 1 to 0. The principles described above can be easily adapted for multi-bit rate control commands.

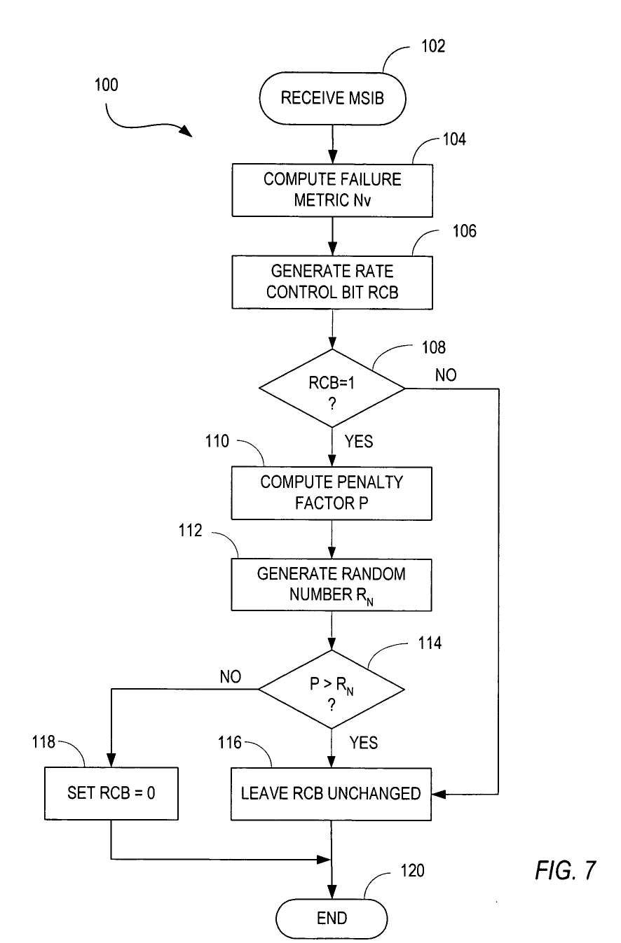

FIG. 7 illustrates an exemplary program 100 executed by the rate controller 60 shown in FIG. 6. The program 100 begins when the rate controller 60 receives the MSIB from the mobile station 12 (block 102). The rate controller 60 computes the number of rate control violations N_{V} over a sliding window W (block 104). The command generator 92 generates a RCB based on the MSIB in a conventional manner well known in the art (block 106). The policing unit 94 examines the value of the RCB from the command generator 92 (block 108). If the RCB equals 1, the penalty unit 98 computes the penalty factor P (block 110) and a random member R_{N} is generated (block 112). The policing unit 94 compares the penalty factor P to the random number R_{N} (block 114). If the penalty factor P is greater than the random number R_{N}, the policing unit 94 leaves the RCB from the command generator 92 unchanged (block 116). If the penalty factor P is less than the random number R_{N}, the policing unit 94 sets the RCB equal to 0 (block 118) and the process ends (block 120). If the RCB generated by the command generator 92 equals 0 (block 108), the policing unit 94 leaves the RCB unchanged (block 116) and the process ends (block 120).

The policing unit 64, 94 of the present invention mitigates the impact of mobile stations 12 that consistently fail to transmit at a granted rate and consequently waste communication resources. The present invention provides more fairness in allocation of resources between mobile stations 12 that accurately estimate power headroom and buffer levels, and those that consistently overestimate power headroom and buffer levels. Without the policing mechanism, a greedy mobile station 12 would be consistently granted higher rates than well-behaving mobile stations 12 that accurately estimate power headroom and buffer levels. The policing mechanism penalizes the greedy mobile stations 12 for this behavior, providing greater fairness to well-behaved mobile stations 12. Additionally, because fewer resources are wasted on greedy mobile stations 12, the policing mechanism achieves a higher system throughput and consequently higher system capacity. The higher system throughput also means that the average delay for delivery of packets is reduced.

The present invention may, of course, be carries out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of controlling the data transmission rate of a mobile station on a reverse packet data channel, comprising:
tracking rate control violations by the mobile station; and
controlling the data transmission rate of the mobile station based on said rate control violations.

2. The method of claim 1 wherein the rate control violations comprise failures by the mobile station to transmit at a an expected rate after indicating a need for a rate increase.

3. The method of claim 1 wherein the rate control violations comprise failures by the mobile station to increase its data rate in response to rate control commands by the base station after indicating a need for a rate increase.

4. The method of claim 1 wherein the rate control violations comprise transmitting frames with an unacceptably high error rate after indicating a need for a rate increase.

5. The method of claim 1 wherein tracking rate control violations by the mobile station comprises detecting rate control violations over a predetermined window comprising one or more frames, and generating a violation level indicating the level of rate control violations by the mobile station over said predetermined window.

6. The method of claim 5 wherein generating said violation level comprises determining variances between a granted rate and an actual transmit rate of the mobile station in one or more frames, and calculating said violation level as a function of said variances.

7. The method of claim 6 wherein calculating said violation level as a function of said variances comprises computing a normalized difference for one or more frames, and summing the normalized differences for one or more frames in said predetermined window to generate the violation level.

8. The method of claim 7 wherein computing said normalized difference for one or more frames comprises computing a ratio of the variance to the granted rate.

9. The method of claim 5 wherein generating a violation metric comprises counting a number of rate control violations over said predetermined window, and calculating said violation level as a function of the number of rate control violations.

10. The method of claim 5 wherein controlling the data transmission rate of the mobile station based on said rate control violations comprises determining a rate control command as a function of said violation level.

11. The method of claim 10 wherein determining said rate control command as a function of said violation level comprises:
computing a rate increase probability; and
granting a rate increase probabilistically based on said rate increase probability.

12. The method of claim 10 wherein determining said rate control command as a function of said violation level comprises:
computing a provisional rate;
computing a penalty factor based on said violation level; and
scaling the provisional rate based on said penalty factor to determine a scheduled rate for the mobile station.

13. The method of claim 10 wherein determining a rate control command as a function of said violation level comprises:
determining a provisional rate control command;
computing a penalty factor based on said violation level; and
modifying the provisional rate control command based on the penalty factor to generate a final rate control command.

14. The method of claim 1 wherein controlling the data transmission rate of the mobile station based on said rate control violations comprises determining a rate control command as a function of said rate control violations.

15. The method of claim 14 wherein determining said rate control command as a function of said rate control violations comprises:
computing a rate increase probability; and
granting a requested rate increase from the mobile station probabilistically based on said rate increase probability.

16. The method of claim 14 wherein determining said rate control command as a function of said rate control violations comprises:
computing a provisional rate;
computing a penalty factor based on said rate control violations; and
scaling the provisional rate based on said penalty factor to determine a scheduled rate.

17. The method of claim 14 wherein determining said rate control command as a function of said variance comprises:
determining a provisional rate control command;
computing a penalty factor based on said rate control violations; and
modifying the provisional rate control command based on the penalty factor to generate a final rate control command.

18. A base station comprising:
a rate controller to detect rate control violations by a mobile station transmitting on a reverse packet data channel, and to generate rate control commands to control the data transmission rate of a mobile station.

19. The base station of claim 18 wherein the rate control violations comprise failures by the mobile station to transmit at an expected rate after indicating a need for a rate increase.

20. The base station of claim 18 wherein the rate control violations by the mobile station comprise failures by the mobile station to increase its data rate in response to rate control commands by the base station after indicating a need for a rate increase.

21. The base station of claim 18 wherein the rate control violations by the mobile station comprise transmitting an unacceptable number of frames in error after indicating a need for a rate increase.

22. The base station of claim 18 wherein the rate controller comprises:
a rate scheduler to determine a scheduled rate for said mobile station; and
a policing unit to modify the scheduled rate based on said rate control violations.

23. The base station of claim 22 wherein the policing unit includes a tracking unit to detect rate control violations by the mobile station over a predetermined window comprising one or more frames, and to generate a violation level indicating the level of rate control violations by the mobile station over said predetermined window.

24. The method of claim 23 wherein the tracking unit generates said violation level by determining variances between a granted rate and an actual transmit rate of the mobile station in one or more frames, and calculating said violation level as a function of said variances.

25. The base station of claim 24 wherein the tracking unit calculates said violation level as a function of said variances by computing a normalized difference for one or more frames, and summing the normalized differences for said one or more frames to generate the violation.

26. The base station of claim 25 wherein the tracking unit computes said normalized difference for one or more frames in said predetermined window by computing a ratio of the variance to the granted rate.

27. The base station of claim 23 wherein the tracking unit generates said violation level by counting a number of rate control violations over said predetermined window, and calculating said violation level as a function of the number of rate control violations.

28. The base station of claim 23 wherein the policing unit includes a penalty unit to determine a penalty factor based on said violation level, and to modify the scheduled rate based on the penalty factor.

29. The base station of claim 28 wherein the penalty unit modifies the scheduled rate based on said violation level.

30. The base station of claim 28 wherein the penalty unit probabilistically grants permission to the mobile station to transmit at the scheduled rate based on the penalty factor.

31. The base station of claim 18 wherein the rate controller includes:
a rate command generator to generate rate control commands; and
a policing unit to modify one or more rate control commands based on said rate control violations.

32. The base station of claim 31 further wherein the policing unit includes a tracking unit to detect rate control violations by the mobile station over a predetermined window comprising one or more frames, and to generate a violation level indicating the level of rate control violations by the mobile station over said predetermined window.

33. The base station of claim 32 wherein the tracking unit generates a violation level by counting a number of rate control violations over said predetermined window, and calculating said violation level as a function of the number of rate control violations.

34. The base station of claim 32 wherein the policing unit further includes a penalty unit to compute a penalty factor as a function of the violation level and to modify one or more rate control commands from the rate command generator based on the penalty factor.

35. The base station of claim 34 wherein the penalty unit calculates a rate increase probability and modifies one or more rate control commands from the command generator based on the rate increase probability.

36. The base station of claim 18 wherein the rate controller determines a rate control command as a function of said rate control violations.

37. The base station of claim 36 wherein the rate control command comprises a differential rate control command.

38. The base station of claim 37 wherein the rate controller probabilistically changes the differential rate control command based on the said rate control violations by said mobile station.

39. The base station of claim 36 wherein the rate control command comprises an absolute rate control command.

40. The base station of claim 39 wherein the rate controller determines a scheduled rate based on said rate control violations by said mobile station.

41. The base station of claim 39 wherein the rate controller probabilistically grants permission to the mobile station to transmit at a scheduled rate based on said rate control violations by said mobile station.
